(19) United States
(12) Patent Application Publication
(10) Pub. No.: US 2015/0310532 A1
(43) Pub. Date: Oct. 29, 2015

(54) VEHICLE TRUNKS FOR COMMERCE

(71) Applicant: EBAY INC., San Jose, CA (US)

(72) Inventors: Ron Gura, Tel Aviv (IL); Matanya Bar, Tel Aviv (IL); Erez Dickman, Tel Aviv (IL)

(21) Appl. No.: 14/260,696

(22) Filed: Apr. 24, 2014

(51) Int. Cl. G06Q 30/06; G06Q 50/30; G06Q 10/06

(52) U.S. Cl. CPC G06Q 30/0633; G06Q 10/06311; G06Q 50/30

(57) ABSTRACT

Methods and systems for promoting commerce by using the trunks of vehicles for hire are described. The trunks can be used to transport, sell, and/or rent merchandise. When a user needs a vehicle for transportation or delivery, a service provider receives the request and locates a vehicle for hire that meets the request. More specifically, the service provider ensures that the trunk of the vehicle has the space to transport any items to be delivered and includes items that are useful for the passenger at his or her destination.

### BACKGROUND

1. Field of the Invention

The present invention generally relates to the use of vehicle trunks for delivering, selling, and/or renting items.

2. Related Art

In a busy metropolis, a for-hire vehicle, such as a taxicab, is generally used for transporting a passenger from one location to another. For-hire vehicles are common in tourist destinations, business traveler destinations (for example, where convention centers are prevalent), or in densely populated urban areas where vehicle ownership is uncommon or impractical. For-hire vehicles are convenient to use and often provide door-to-door service.

### BRIEF DESCRIPTION OF THE FIGURES

FIG. 1 is a block diagram illustrating a system for promoting commerce according to an embodiment of the present disclosure;

FIG. 2 is a flowchart showing a method for promoting commerce according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that utilize the trunk of a vehicle for hire to transport, sell, and/or rent merchandise. The trunks of for-hire vehicles are generally unutilized. These vehicles travel to different destinations around the city, and their trunks are empty, which wastes space that could be used. Vehicles for hire can include taxicabs, limousines, shuttles, or any other vehicle that provides shared transportation or transports one or more passengers between locations of the passengers' choice. When a user needs a vehicle for transportation or delivery, he or she sends a request to a service provider. The request may include destination or user preference information. The service provider receives the request and locates a vehicle that meets the user request. The vehicle transports the user and/or any items provided by the user to the desired destination. The trunk in the vehicle is used to move, sell, and/or rent items to the user.

In one embodiment, one or more items are to be delivered, and the items are placed in the trunk of the vehicle. The items may include electronics, musical instruments, antiques and collectibles, clothes and shoes, sporting goods and accessories, automotive parts and accessories, and high-end kitchen appliances. In another embodiment, the user is to be transported to a location. The vehicle picks the user up, and the vehicle trunk includes items that are based on the location and/or any user preferences. The items are available for rent or purchase by the user. When the user arrives at the location, the user can pay for both the items and vehicle transportation in one payment. In yet another embodiment, one or more packages are to be delivered and the user wants to be taken to a location.

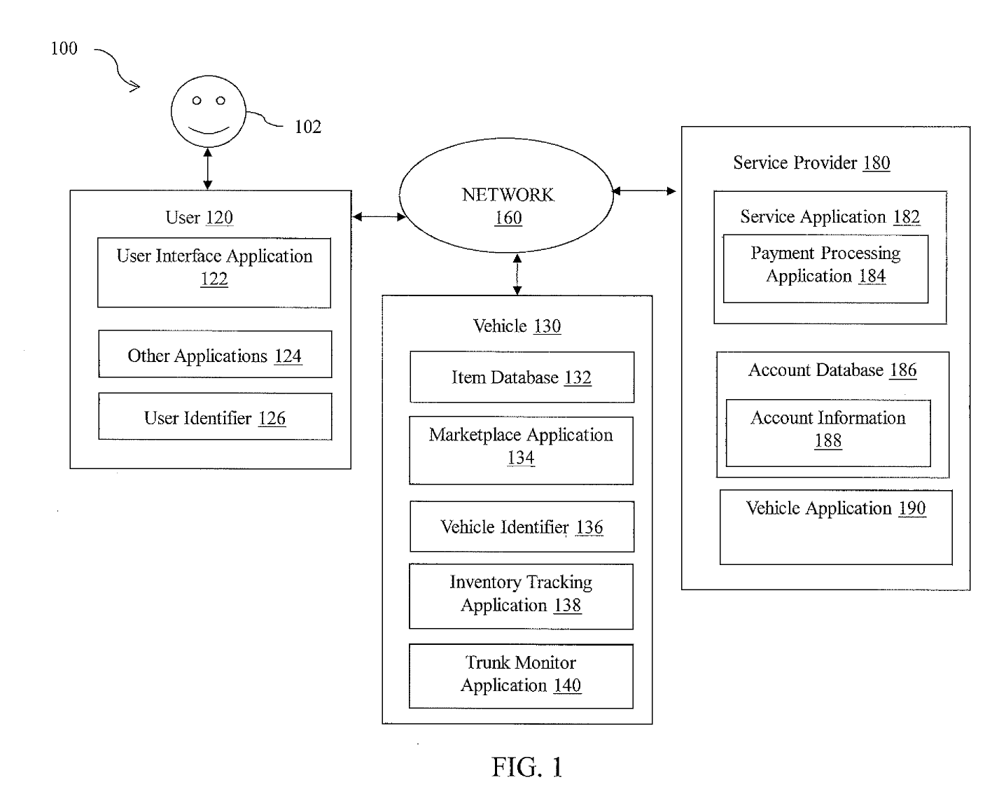

FIG. 1 shows one embodiment of a block diagram of a network-based system 100 adapted to promote commerce with a user device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), one or more vehicle devices 130 (e.g., tablet), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 120, in one embodiment, may be utilized by the user 102 to interact with the vehicle device 130 and/or the service provider server 180 over the network 160. For example, the user 102 may conduct financial transactions (e.g., account transfers) with the service provider server 180 via the user device 120. The user device 120, in various embodiments, may be implemented using any appropriate combination of hardware and/or software configured for wired and/or wireless communication over the network 160. In various implementations, the user device 120 includes a wireless telephone (e.g., cellular or mobile phone), a tablet, a personal computer, a notebook computer, a wearable computing device, and/or various other generally known types of wired and/or wireless computing devices.

The user device 120, in one embodiment, includes a user interface application 122, which may be utilized by the user 102 to conduct transactions (e.g., shopping, purchasing, bidding, etc.) with the vehicle device 130 and/or service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to purchase or rent items from the one or more vehicle devices 130 via the service provider server 180. Accordingly, in one or more embodiments, the user 102 may conduct transactions (e.g., purchase and provide payment for one or more items and transport service) from the one or more vehicle devices 130 via the service provider server 180.

The user device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the user device 120 (e.g., cell phone). The user profile may be updated with each financial and/or information transaction (e.g., payment transaction, purchase transaction, etc.) achieved through use of the user device 120. In various aspects, this may include the type of transaction and/or the location information from the user device 120. As such, the profile may be used for recognizing patterns of potential fraud, setting transaction limits on the user, etc.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The one or more vehicle devices 130, in various embodiments, may be maintained by one or more business entities (or in some cases, by a partner of a business entity that processes transactions on behalf of business entities). The vehicle device 130 may be integrated into the vehicle, or merely placed inside the vehicle (e.g., iPad®). The vehicle device 130 may also transmit information to a centralized location of the operator or owner of the vehicle for hire. In some embodiments, business entities may need registration of user information as part of offering items to the user 102 over the network 160. As such, each of the one or more vehicle devices 130 may include an item database 132 for identifying available items, which may be made available to the user device 120 or vehicle device 130 for viewing and purchase by the user 102. In one or more embodiments, user 102 may complete a transaction such as purchasing or renting the items via service provider server 180.

The vehicle device 130, in some embodiments, includes an inventory tracking application 138. The inventory tracking application 138 is operable to keep track of inventory of items that are available for rent or purchase in the trunk of the vehicle. The inventory tracking application 138 is also operable to communicate inventory information of items in the vehicle trunk to the service provider server 180 to allow the service provider to identify the inventory information. Inventory information can include product data such as items available at specific times of the day; data concerning items available when the vehicle is located in proximity to specific locations; and data concerning quantity of items stocked in the vehicle trunk.

In various embodiments, the trunk of the vehicle is locked and may be restocked with items at a centralized starting and ending point. Items may include such things as a food item (e.g., mints, candy, gum, etc.), a beverage item (e.g., an energy drink, water, juice, etc.), condoms, cigarettes, weather-related items (e.g., umbrella, coat, poncho, etc.), toys (e.g., stuffed animals, puzzles, children's books, etc.) or a medicinal item (e.g., pain killer, heartburn relief or aspirin, etc.). It is to be understood that these are examples only and other items can be made available in the trunk, such as hair care items, makeup, office supplies, etc.

In other embodiments, the vehicle device 130 includes a trunk monitor application 140. The trunk monitor application 140 monitors the space available or left in the trunk of the vehicle to ensure that the trunk has the capacity to transport items provided by the user 102 (e.g., suitcases, luggage, delivery packages, etc.) and/or any other items for purchase or rent by the user 102 (e.g., gum, drinks, food, etc.). For example, a user 102 may indicate that they have a medium sized suitcase so the trunk cannot be completely filled with other items. In another example, the user 102 may indicate that he or she wants a large box delivered so the trunk can only be filled with a minimum amount of other items.

Each of the vehicle devices 130, in one embodiment, may include a marketplace application 134, which may be configured to provide information over the network 160 to the user interface application 122 of the user device 120. For example, user 102 may interact with the marketplace application 134 through the user interface application 122 over the network 160 to search and view various items available for purchase in the item database 132.

Each of the vehicle devices 130, in one embodiment, may include at least one vehicle identifier 136, which may be included as part of the one or more items made available for purchase so that, e.g., particular items are associated with particular vehicles. In one implementation, the vehicle identifier 136 may include one or more attributes and/or parameters related to the operator of the vehicle, such as business and banking information. The vehicle identifier 136 may include attributes related to the vehicle device 130, such as identification information (e.g., a serial number, a location address, GPS coordinates, a network identification number, etc.). In various embodiments, user 102 may conduct transactions (e.g., searching, selection, monitoring, purchasing, renting, and/or providing payment for items) with each vehicle device 130 via the service provider server 180 over the network 160.

In an embodiment, the vehicle device 130 includes a screen or display that offers the user 102 a variety of items for purchase or rent. The user 102 can select to purchase or rent multiple quantities of any selected item. The screen or display displays visualizations of items available for purchase or rent immediately. These items may be stored within the vehicle trunk. The screen may have several pages of different items available for view and purchase or rent. The items may or may not change regularly or be wholly different in various regions or at various times of the day.

The vehicle device 130 may integrate with the existing transportation meter or payment system and allow for payment of the fare at the same time as payment for the items. The vehicle device 130 may integrate payment of the transportation fare with payment of the items and receive a consolidated payment. In one embodiment, the display of the vehicle device 130 displays both the fare for the vehicle as well as the cost of the items on the same display.

The service provider server 180, in one embodiment, may be maintained by a transaction processing entity or an online service provider, which may provide processing for financial transactions and/or information transactions between the user 102 and one or more of the vehicle devices 130. As such, the service provider server 180 includes a service application 182, which may be adapted to interact with the user device 120 over the network 160 to facilitate the searching, selection, purchase, and/or payment of items by the user 102 from the one or more vehicle devices 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the vehicle devices 130. In one implementation, the payment processing application 184 assists with resolving financial transactions through validation, delivery, and settlement. As such, the service application 182 in conjunction with the payment processing module 184 settles indebtedness between the user 102 and each of the vehicle devices 130, wherein accounts may be directly and/or automatically debited and/or credited of monetary funds in a manner as accepted by the banking industry.

The service provider server 180, in one embodiment, may be configured to maintain one or more user accounts and vehicle accounts in an account database 186, each of which may include account information 188 associated with one or more individual users (e.g., user 102) and operators of vehicles for hire. For example, account information 188 may include private financial information of user 102 and operators (e.g., one or more operators associated with vehicle devices 130), such as one or more account numbers, passwords, credit card information, banking information, or other types of financial information, which may be used to facilitate financial transactions between user 102, and one or more vehicle operators associated with the vehicle devices 130. In various aspects, the methods and systems described herein may be modified to accommodate users and/or vehicle operators that may or may not be associated with at least one existing user account and/or operator account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes a vehicle application 190. The vehicle application 190 receives vehicle requests from the user 102, locates a vehicle for hire that meets the vehicle request, dispatches the vehicle for hire to the user location, and processes payment for use of the vehicle for hire and any items purchased or rented from the vehicle for hire. In an exemplary embodiment, the vehicle request includes a user destination or location. Based on the location, the vehicle application 190 can identify a selection of items related to the location. For example, if the user 102 plans to go to the beach, the items placed in the trunk can include beach umbrellas, towels, sunscreen, sunglasses, surfboard, wetsuit, flippers, etc. If the user's destination is a sporting event, the items in the trunk can include sports paraphernalia such as jerseys, t-shirts, and caps, and binoculars. In an embodiment, identifying a selection of items related to the location can include identifying, for example, event tickets for an event that will take place at a venue that is proximate to the location and/or it can include identifying discounts for at least one product or service at a venue that is proximate to the location. When the vehicle application 190 detects that a destination is near a location of a venue, it can display the availability of tickets or a discount for those locations on the user device 120 or the vehicle device 130, along with information concerning the location (such as advertising for the venue). The vehicle request may also include certain user preferences such as specific types of food (e.g., potato chips, soda, gluten-free foods, non-dairy foods, etc.), specific types of toys (e.g., children's books, action figures, dolls, Lego® blocks, etc.), specific toiletries (e.g., soap, toothbrush, toothpaste, hand sanitizer, etc.), and specific electronic gadgets (e.g., radio, iPad®, iPod®, etc.). The service provider server 180 can then ensure that the trunk of the vehicle includes these user preferences.

The vehicle application 190, in various aspects, can determine when the vehicle is in between rides, e.g., when the vehicle is not transporting passengers. The vehicle application 190 can access the schedule of appointments for the vehicle, and provide delivery jobs to the vehicle during down times. For example, the vehicle application can inform the vehicle that the user 102 needs an item delivered, and the vehicle can pick up the item. The vehicle can pick up additional items and deliver the items in between rides.

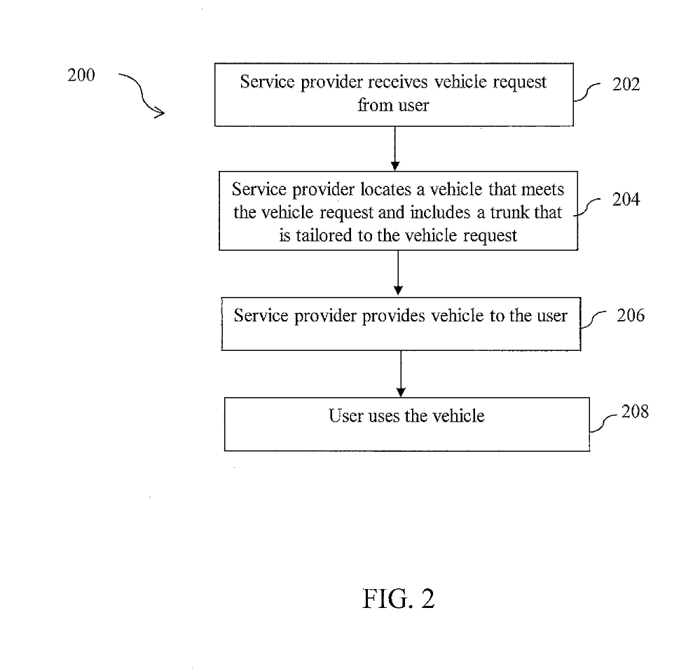

Referring now to FIG. 2, a flowchart 200 of a method for promoting commerce is illustrated according to an embodiment of the present disclosure. In various embodiments, the user 102 registers with a service provider. Registration may include signing up for the service and agreeing to any terms required by the service provider, such as through user device 120. In one embodiment, the user device 120 is a mobile computing device, such as a smart phone, a PC, or a computing tablet. In other embodiments, registration may be done completely through the user device 120, partially through the user device 120, or without using the user device 120, such as through a phone call or in-person visit to a representative of the service provider.

The user 102 may be requested to provider specific information for registration, such as, but not limited to, a name, address, phone number, email address, picture, a user name for the account, and a password or PIN for the account. The type of information requested may depend on whether the user 102 already has an account with the service provider. Requested information may be entered through the user device 120 or other means, including voice or manual key entry. Once all the requested information is received and confirmed, the service provider may create an account for the user.

At step 202, the user 102 contacts the service provider server 180 with a vehicle request and the service provider server 180 receives the request. The vehicle request may include various kinds of information such as the type of vehicle for hire desired, user preferences for items in the trunk, number of people to be transported, items to be transported, amount of luggage, pick-up location, drop-off location or destination, time of departure, time of arrival, etc. The type of vehicle can be a taxi, van, shuttle bus, rental car, limousine, small vehicle, mid-size vehicle, large vehicle, etc. The number of people can be designated as one person, two people, family, large group, family with pets, etc. Items to be transported can be designated as small, medium-sized, large, bulky, etc. The drop-off location can be a delivery site (e.g., retail location), house, museum, theater, park, venue, etc.

At step 204, the service provider server 180 locates a vehicle for hire that meets the user request and includes a trunk that is tailored to the vehicle request and/or information about people who will riding in the vehicle. For example, the user 102 indicates that he or she has a family of five and a golden retriever, and their destination is an outdoor concert. Based on this information, the service provider server 180 selects a large sports utility vehicle for the user 102 with enough space to sit five people comfortably with the dog. The trunk of the SUV is filled with items that are useful for the outdoor concert, such as a large blanket, binoculars, light jackets, hats, snacks, drinks, hand sanitizer, camera, sunblock, foldable chairs, backpacks/bags, dog treats, etc. The user 102 is allowed to rent or purchase any of these items. Items may be selected based on specific user preferences, such as whether the user typically splurges on certain events, is frugal, rents, buys, is out for a special occasion, etc. Different items may be selected for different passengers going to the same destination, again based on user preferences, such as past purchases, search history, etc. Items may be selected based on special events for the user, such as a birthday of a child, an anniversary, etc., such that the items may include suggested gifts the user may purchase for someone else. In another example, the user 102 wants to deliver a package. The user 102 contacts the service provider server 180 with this request. The service provider server 180 finds a vehicle with a trunk that has the space for the package and that has the time to deliver the package.

At step 206, the service provider server 180 provides the vehicle for hire to the user 102. In various embodiments, the vehicle for hire is dispatched to a location to pick up the user and/or any items for delivery. In other embodiments, the user 102 arrives at a central location to pick up the vehicle.

At step 208, the vehicle for hire is used by the user 102. In one embodiment, the user 102 uses the vehicle to deliver items. For example, the user 102 can place items for delivery in the trunk of the vehicle, and the driver of the vehicle can transport the item to a desired destination.

In an exemplary embodiment, the user 102 wants to sell an item with the assistance of a valet, and the vehicle transports the item to a designated drop-off center. The valet accepts and attempts to sell the item. The user 102 receives a portion (e.g., 70%) of the sale proceeds for the sold item. It is often a nuisance and often quite difficult for individuals to find time to drop off packages, and the trunk of the vehicle can be used to transport multiple items from a plurality of users to the drop-off center. These drop-off centers may advantageously be kiosks or other small or freestanding structures, such as counters for acceptance of packages. The packages are dropped off at one or more of the drop-off centers over the course of a day. Advantageously, the driver of the vehicle can pick up and drop off the items at the drop-off centers in between rides. Upon delivery, the driver of the vehicle can be compensated through, for example, the service provider server 180.

In another embodiment, the user 102 wants to travel to a location. The user 102 gets in the vehicle to drive himself or herself to the destination, or a driver of the vehicle transports the user 102 to the destination. In the vehicle, the user 102 can view and select items in the trunk that are available for rent or purchase on the user device 120 or the vehicle device 130.

Upon reaching the destination, the user 102 can pay for use of the vehicle, along with any items purchased or rented, through the service provider server 180. The purchase or rental price of any items in the trunk can be combined with the vehicle service, such as the fare of a taxicab to arrive at the destination. In this manner, as the user 102 sits in the back of the vehicle, he or she can purchase or rent one or more items from the trunk, and the purchase or rental price is added to the fare of the vehicle. When the user 102 arrives at his or her destination, the user 102 can pay for both the fare and the purchase/rental price of the items in a single transaction, using a frictionless payment system provided by the service provider. Advantageously, the trip fare and the item costs are collected together. This provides convenience to the user 102 because there is no need to pay separate transactions for the items and the trip costs. The payment can be collected in one step. In the case where items are rented, the items can be returned to the trunk of the vehicle when the vehicle takes the user 102 back home. The vehicle may be the same vehicle that dropped the user 102 off, or may be a different vehicle.

The present disclosure describes systems and methods that effectively utilize the space available in vehicle trunks. The trunks can be used to transport and deliver items, as well as to store merchandise that can be rented or sold to passengers. In various embodiments, the merchandise placed in the trunk is based on the destination of the passenger.

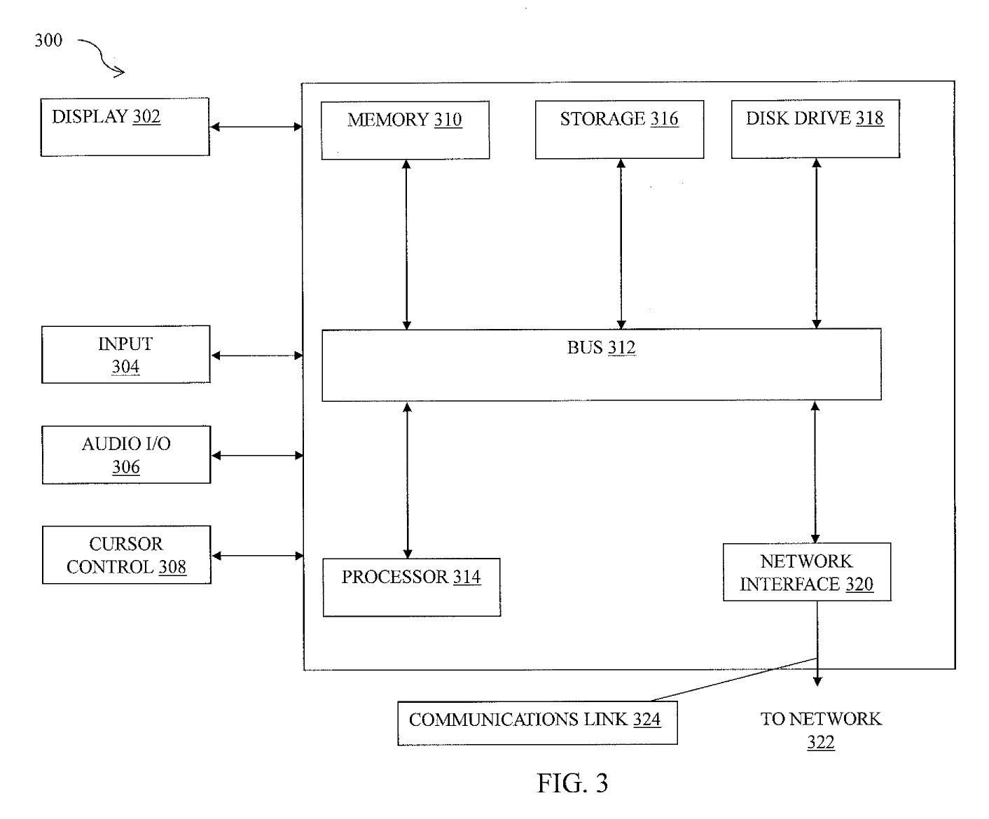

FIG. 3 is a block diagram of a computer system 300 suitable for implementing one or more embodiments of the present disclosure, including the user device 120, vehicle device 130, and the service provider server 180. In various implementations, the user device 120 or vehicle device 130 may comprise a mobile cellular phone, personal computer (PC), laptop, wearable computing device, etc, adapted for wireless communication, and the service provider server 180 may comprise a network computing device, such as a server. Thus, it should be appreciated that the devices 120, 130, and 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, service provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a service provider server via network 322. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device; and
one or more processors in communication with the memory device and operable to:
receive a vehicle request from a user, wherein the request includes delivery of a package, transport of the user to a destination, or both; and
provide a vehicle for hire with a trunk, wherein the trunk includes space for the package, items based on the destination, or both.

2. The system of claim 1, wherein the one or more processors are further operable to display the items that are available for rent to the user.

3. The system of claim 2, wherein the one or more processors are further operable to process payment for use of the vehicle for hire and any items rented from the trunk.

4. The system of claim 1, wherein the delivery request comprises a request to sell items in the package with the assistance of a valet.

5. The system of claim 4, wherein the delivery request further comprises a request to deliver the package to a designated drop-off center.

6. The system of claim 1, wherein the one or more processors are further operable to determine when the vehicle for hire is in between rides.

7. The system of claim 1, wherein the one or more processors are further operable to process payment for delivery of the package.

8. A method for promoting commerce, comprising:
receiving, by one or more hardware processors of a service provider, a vehicle request from a user, wherein the request includes delivery of a package, transport of the user to a destination, or both; and
providing, by the one or more hardware processors, a vehicle for hire with a trunk, wherein the trunk includes space for the package, items based on information about the user, or both.

9. The method of claim 8, further comprising identifying items related to the destination.

10. The method of claim 9, wherein identifying items comprises identifying tickets or discounts proximate to the destination.

11. The method of claim 8, further comprising processing payment for use of the vehicle for hire and any items rented from the trunk.

12. The method of claim 8, further comprising determining when the vehicle for hire is in between rides.

13. The method of claim 12, further comprising providing the vehicle for hire with delivery jobs in between rides.

14. The method of claim 8, wherein the vehicle request comprises user preferences for items in the trunk.

15. A non-transitory machine-readable medium comprising instructions which, in response to a computer system, cause the computer system to perform a method comprising:
receiving a vehicle request from a user, wherein the request includes transport of the user to a destination;
identifying items for the user based on the destination and information about the user; and
providing a vehicle for hire with a trunk, wherein the trunk includes space for the identified items.

16. The non-transitory machine-readable medium of claim 15, wherein the vehicle request comprises user preferences for items in the trunk.

17. The non-transitory machine-readable medium of claim 15, wherein the method further comprises processing payment for use of the vehicle for hire and any items rented from the trunk.

18. The non-transitory machine-readable medium of claim 15, wherein the delivery request further comprises a request to sell a package and deliver the package to a designated drop-off center.

19. The non-transitory machine-readable medium of claim 18, wherein the method further comprises processing payment for delivery of the package.

20. The non-transitory machine-readable medium of claim 15, wherein the method further comprises determining when the vehicle for hire is in between rides.
